(19) United States
(12) Patent Application Publication
(10) Pub. No.: US 2016/0140509 A1
(43) Pub. Date: May 19, 2016

(54) METHODS AND SYSTEMS FOR CREATING, MANAGING, AND COMMUNICATING CALENDAR ENTRIES AND CHANGES

(71) Applicant: Nicholas Powell Beulick, St. Louis, MO (US)

(72) Inventor: Nicholas Powell Beulick, St. Louis, MO (US)

(21) Appl. No.: 14/941,131

(22) Filed: Nov. 13, 2015

Related U.S. Application Data
(60) Provisional application No. 62/079,254, filed on Nov. 13, 2014.

(51) Int. Cl. G06Q 10/10

(52) U.S. Cl. CPC G06Q 10/1095

(57) ABSTRACT

Methods and systems for creating, managing, and communicating calendar entries and changes are described. In one example, the method includes receiving at a computing device, via a user interface, data related to an event. The data includes at least one of an event date, an event time, an event location, and an event type. The event data is stored in a memory of the computing device. The event data is transmitted, via a communication interface of the computing device, to user devices. Event confirmation data is received, via the communication interface, from the user device indicating receipt of the event data.

### BACKGROUND OF THE INVENTION

The field of the invention relates generally to electronic calendars, and more particularly, to coordination of multiple calendars across a broad population of interested parties and subscribers. Such electronic calendars can be used as stand-alone calendars, accessible by other applications, and partially or wholly integrated into other applications such as social network applications

Paper based calendar systems have been in use for many years, and remain in use today. With such paper based systems, individuals typically manually make calendar entries according to date and time for appointments and other scheduled events. Such paper calendars, however, typically are kept at a particular location (e.g., on a desk and/or near a telephone) and are not carried by the individuals. Unless the individual has the calendar with them or has a very good memory, making firm commitments for appointments or other events on particular dates and times may not be highly reliable. In addition, making manual entries is susceptible to errors and is highly dependent on the accuracy of the individual making the entry.

Portable and ultra-portable communication devices, such as smartphones, cellular phones, and personal digital assistants (PDAs), have grown in use and popularity among a variety of different types of users. Many such devices include an electronic calendar. Since users often carry such devices with them, the electronic calendar is readily available for making calendar entries and changes. In addition, each user often has a single calendar accessible by the communication device to facilitate maintaining one single calendar for all commitments and events.

Keeping an electronic calendar on a portable communication device has overcome some shortcomings associated with paper based calendar, although such electronic calendar systems have introduced other challenges. For example, such electronic calendars often still do rely on the calendar owner making manual entries through a keyboard or touch screen.

As electronic and mobile devices continue to proliferate, other challenges have been introduced including the possibility of one individual having multiple electronic calendars to coordinate. With multiple calendars, the possibility for errors continues, including for example double booking a particular date/time. In addition, making a calendar entry or changing a particular previously booked appointment or event often involves a direct conversation between the individuals involved, which can be time consuming, annoying and inefficient particularly if multiple rescheduling attempts are required.

As one example, in an educational environment such as a university, one student may have multiple teachers at any given time. Each teacher may use an electronic calendar for scheduling assignments, quizzes, lab activities, and exams. Each teacher may utilize a different calendar system, which then requires each student to coordinate multiple calendars. Requiring students to coordinate multiple calendars is error prone, and may lead to causing the student to miss certain assignments and other class activities.

### BRIEF DESCRIPTION OF THE INVENTION

Methods and systems for creating, managing, and communicating calendar entries and changes are described. In one example, the method includes receiving at a computing device, via a user interface, data related to an event. The data includes at least one of an event date, an event time, an event location, and an event type. The event data is stored in a memory of the computing device. The event data is transmitted, via a communication interface of the computing device, to user devices. Event confirmation data is received, via the communication interface, from the user device indicating receipt of the event data.

### BRIEF DESCRIPTION OF THE DRAWINGS

FIG. 1 illustrates an example system architecture.

FIG. 2 illustrates an example method for making a calendar entry.

FIG. 3 illustrates an example method for storing a calendar entry at a remote device.

FIG. 4 illustrates an example method for adding group events to a calendar.

FIG. 5 illustrates an example method for a group calendar invitation.

FIG. 6 illustrates an example method for editing a group calendar.

### DETAILED DESCRIPTION OF THE INVENTION

Set forth below are descriptions of various embodiments of calendaring methods and systems that can be used in connection with computer based systems, electronic devices, portable and ultra-portable devices, and any system or device capable of operating an electronic calendar. In addition, which such calendaring methods and systems are sometimes described below in the context of communications performed via the Internet or other electronic based communication networks (e.g., local area networks, wireless networks), such methods and systems are not limited to practice using any one or combination of electronic based communication networks and are not dependent on any one or combination of electronic devices.

Also, various aspects of the methods and systems described below can be practiced independently of each other. For example, automatically communicating calendar changes (e.g., notifications) via selected mediums (e.g., voice, text, e-mail, Facebook) to users of or subscribers to a particular calendar can be practiced independently of other aspects of the methods and systems. Therefore, while the methods and systems are described below in their entirety, those skilled in the art will readily recognize that certain aspects of the methods and systems can be practiced separately.

In one embodiment, a computer program is provided, and the program is embodied on a computer readable medium. In an example embodiment, the system is executed on a single computer system, without requiring a connection to a server computer. In a further example embodiment, the system is run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

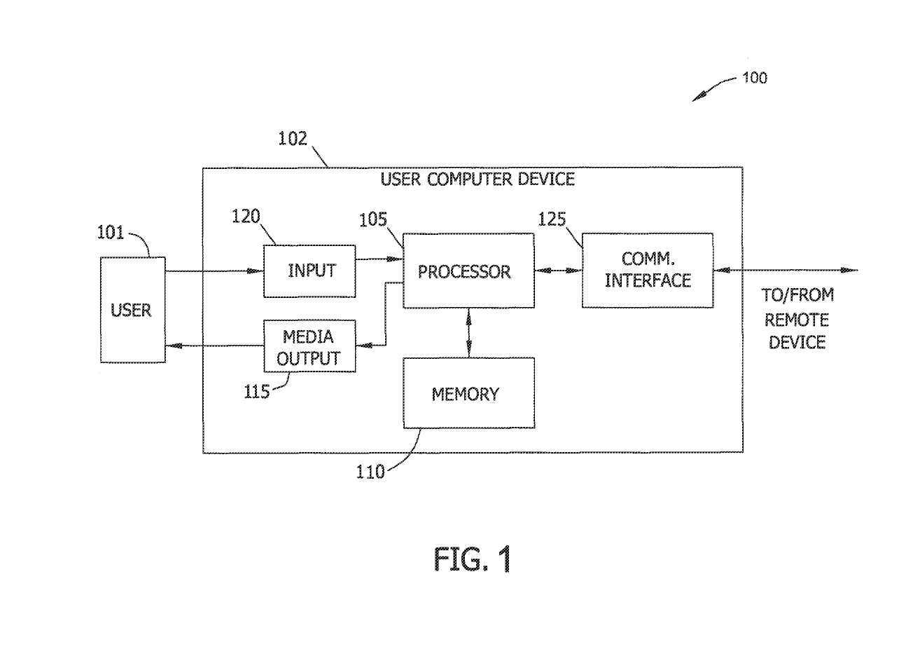

FIG. 1 is a block diagram of an exemplary computing device 100. The generic computing device 100 represents various forms of digital computers, such as laptops, desktops, workstations, personal digital assistants, servers, blade servers, mainframes, tablets, and other appropriate computers. Computing device 100 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

User computer device 102 is operated by a user 101. User computer device 102 includes a processor 105 for executing instructions. In some embodiments, executable instructions are stored in a memory area 110. Processor 105 may include one or more processing units (e.g., in a multi-core configuration). Memory area 110 is any device allowing information such as executable instructions and/or transaction data to be stored and retrieved. Memory area 110 may include one or more computer readable media.

User computer device 102 also includes at least one media output component 115 for presenting information to user 101. Media output component 115 is any component capable of conveying information to user 101. In some embodiments, media output component 115 includes an output adapter (not shown) such as a video adapter and/or an audio adapter. An output adapter is operatively coupled to processor 105 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 115 is configured to present a graphical user interface (e.g., a web browser and/or a client application) to user 101. A graphical user interface may include, for example, an online store interface for viewing and/or purchasing items, and/or a wallet application for managing payment information. In some embodiments, user computer device 102 includes an input device 120 for receiving input from user 101. User 101 may use input device 120 to, without limitation, select and/or enter one or calendar entry and/or request, or to access credential information, and/or other personal information. Input device 120 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 115 and input device 120.

User computer device 102 may also include a communication interface 125, communicatively coupled to a remote device. Communication interface 125 may include, for example, a wired or wireless network adapter and/or a wireless data transceiver for use with a mobile telecommunications network.

Stored in memory area 110 are, for example, computer readable instructions for providing a user interface to user 101 via media output component 115 and, optionally, receiving and processing input from input device 120. A user interface may include, among other possibilities, a web browser and/or a client application. Web browsers enable users, such as user 101, to display and interact with media and other information typically embedded on a web page or a website. A client application allows user 101 to interact with, for example, a server system. For example, instructions may be stored by a cloud service, and the output of the execution of the instructions sent to the media output component 115.

Processor 105 executes computer-executable instructions for implementing aspects of the disclosure. In some embodiments, the processor 105 is transformed into a special purpose microprocessor by executing computer-executable instructions or by otherwise being programmed.

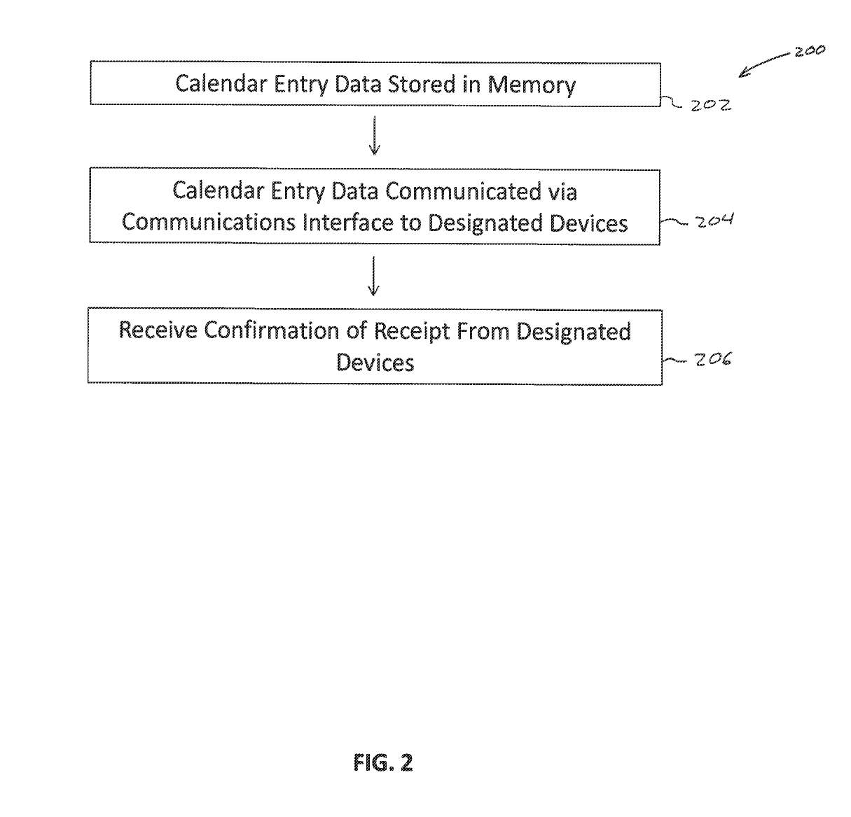

FIG. 2 illustrates an example method 200 for making a calendar entry using device 102. Specifically, in one example and with reference to FIGS. 1 and 2, calendar entry data is stored in memory 110 as illustrated at step 202. The calendar entry data is communicated via communications interface 125 to designated remote devices, as illustrated at step 204. Device 102 then receives, at communication interface 125, confirmation of receipt of such calendar entry data from the designated remote devices, as illustrated at step 206.

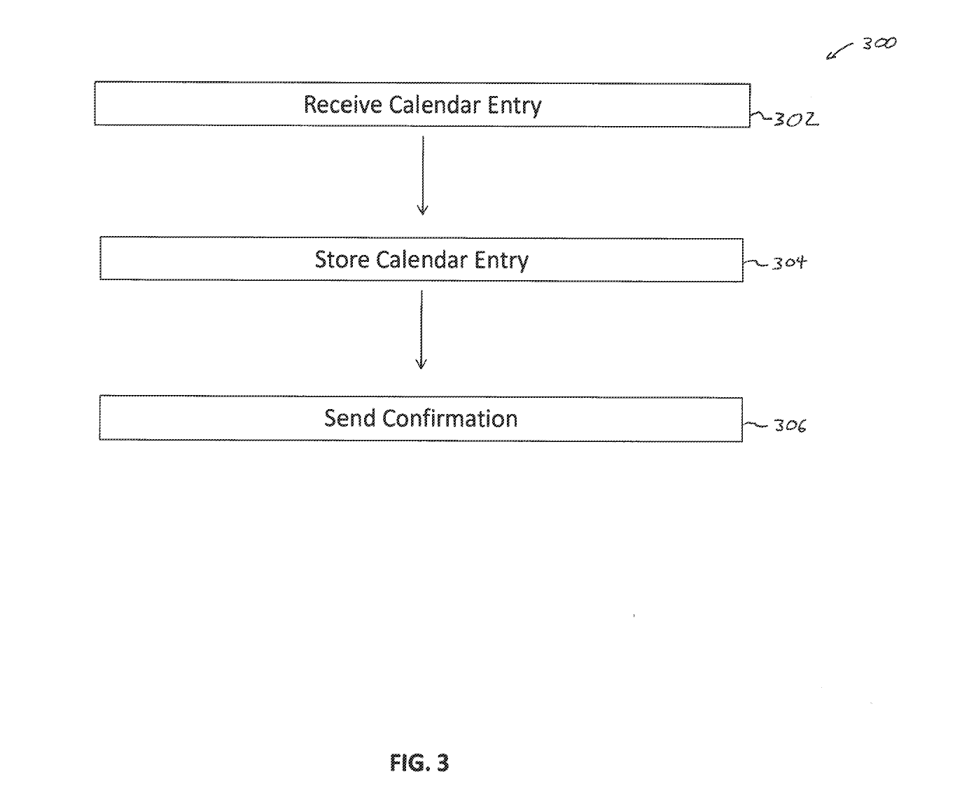

FIG. 3 illustrates an example method 300 for storing a calendar entry at a remote device. Specifically, and in one example, calendar entry data is received at the remote device 302. The calendar data is then stored 304 at remote device, and the remote device transmits a confirmation 306.

The remote device represents various forms of digital computers, such as laptops, desktops, workstations, personal digital assistants, servers, blade servers, mainframes, tablets, and other appropriate computers. The remote device also represents various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

The Basic Calendar

In one aspect, the present system includes a database accessible by a plurality of devices via a wide area network such as the Internet. User-created calendars are stored in the database, and typically are password protected so that access is limited to the specific user and others allowed access by the user. The user creates calendar entries that are stored in the database.

The Group Calendar

In addition to individual entries by a particular user, the calendar system is configured to allow group calendar entries and coordination of such entries for an entire group. There are many examples of possible groups, including any user defined group such as a sports team, a social network, and students in a particular class. Examples are set forth below, along with examples of managing authorized access to a calendar and notifications associated with changes to calendar entries.

As one example of a group calendar, a coach (sometimes referred to as a calendar administrator in the context of coordinating team events) for particular sports team may establish a calendar having entries corresponding to team practices and games. Once the calendar is established, the coach may share the calendar password with other team coaches, team players, parents of the team players, and team fans. When a particular calendar authorized user (e.g., coach, player, parents, fans) then accesses the calendar, the user may elect to have all team calendared events downloaded into that particular users calendar. Such election sometimes is referred to herein as subscribing to a particular calendar. If the coach (i.e., calendar administrator in this example) makes a change to any calendar entry, a notification is automatically provided to each calendar user that a change has been made, and that particular change is downloaded into each user's calendar. Such system facilitates avoiding a need to manually input multiple calendar entries, and then manually update each event change.

Significant efficiencies are facilitated by such automatic updating of calendars including that multiple users need not manually make multiple entries in their own respective calendars, nor do such users need to manually make changes/updates. Rather, once a user subscribes to a particular calendar, all calendar entries are automatically loaded into that user's calendar and any updates/changes also are automatically made to that user's calendar.

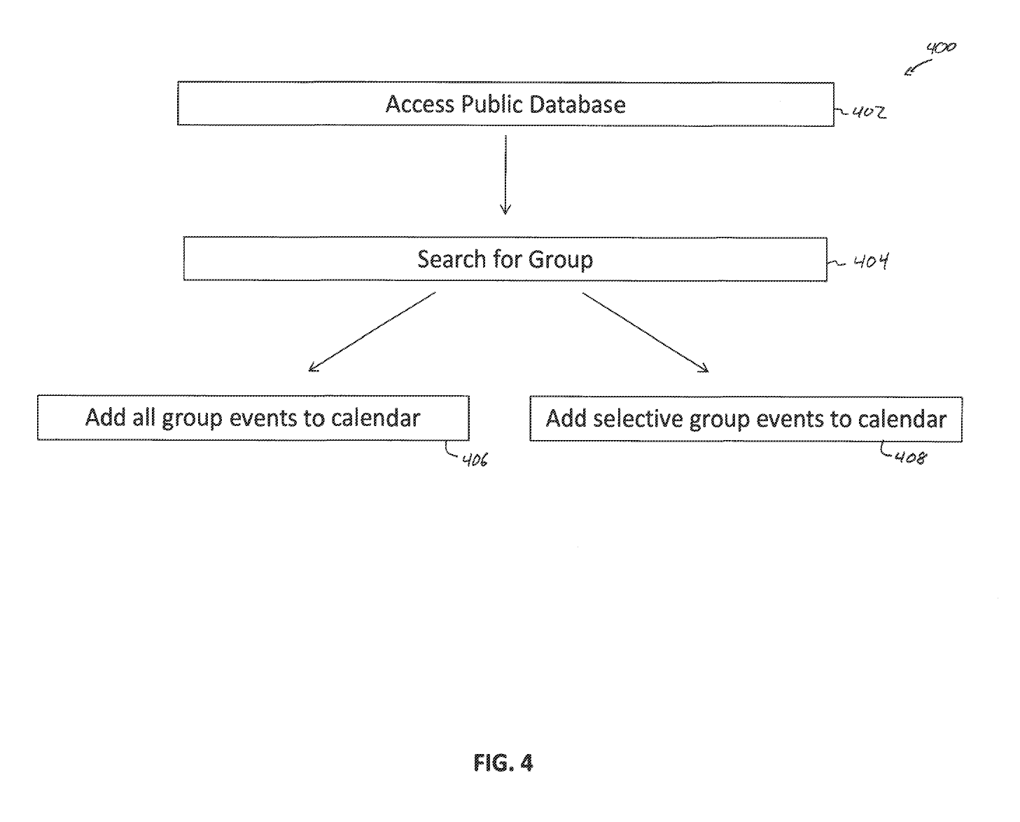

FIG. 4 illustrates an example method 400 for adding group events to a calendar. In the example method 400, a user using the remote device accesses a public database 402 and then searches for a desired group 404. Once that group is located, the user can then select to add all group events to the calendar 406. The user can also add selective group events to the calendar 408.

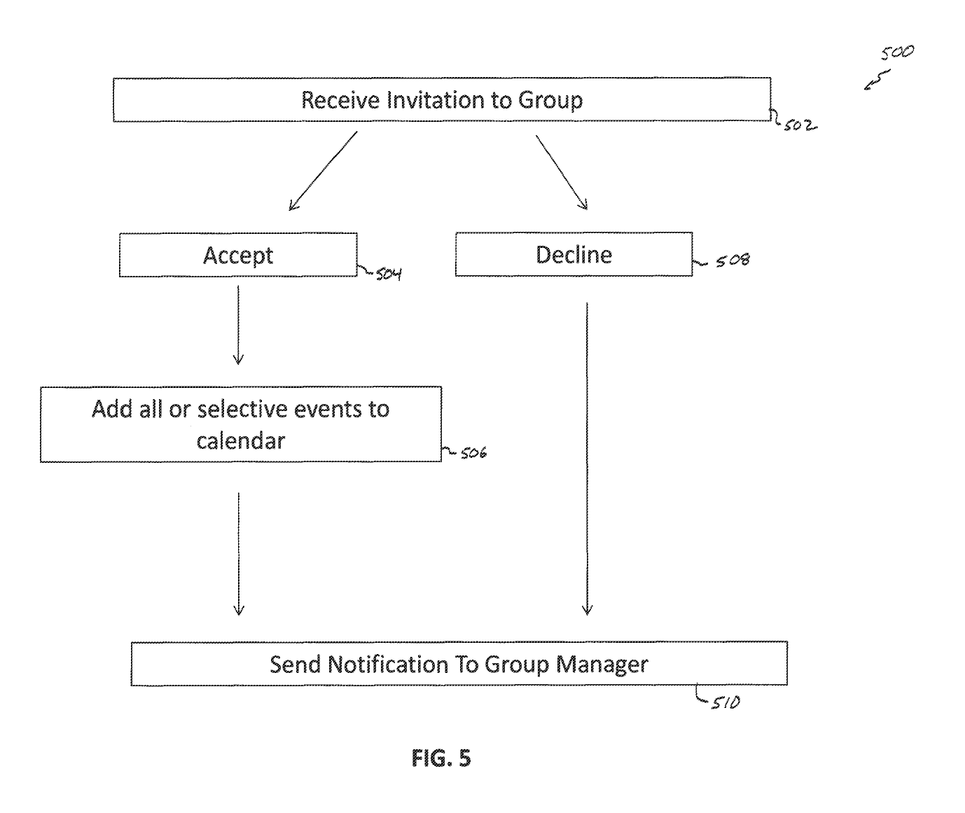

FIG. 5 illustrates an example method 500 for a group calendar invitation. For example, a user may receive, at the remote device, an invitation to join a group 502. If the user accepts 504, then the user can also add all or select group events to the calendar 506. If the user declines 508, or after the user accepts and adds group events to the calendar 506, then a notification is sent to the group manager 510.

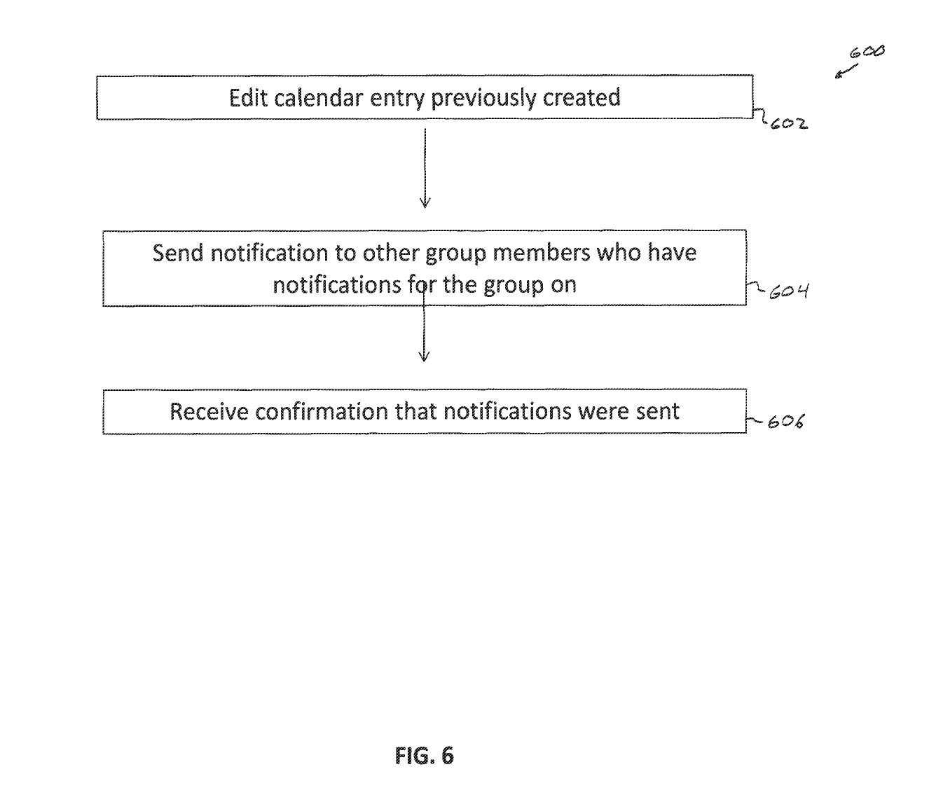

FIG. 6 illustrates an example method 600 for editing a group calendar. In the example method 600, a user edits a calendar entry previously created 602 (e.g., at the remote device or at another computing device). Once the edit is made, then a notification is sent to the group members who have selected to receive group notification 604. The notification may include a statement, for example, that an edit has been made to the group calendar. Once the notifications are sent, the user who makes the calendar edit receives a confirmation that the notifications have been sent 606.

There are many variations and examples with respect to how such calendars are managed and used by any particular user or groups of users. Examples are set forth below.

The Subscriber-Based Calendar

As explained above, subscriber-based calendars can be created with calendars stored in the database. In addition to allowing subscribers access to basic calendar entries associated with a particular group or event, access to certain entries with the calendar can be based on authority levels as defined by the calendar administrator. For example, an administrator for a doctors' office may establish a subscriber-based calendar for all patients seen in the doctors' office. Each patient for each doctor may receive a password, and that password allows each respective patient access to calendar entries associated with educational sessions hosted by the doctors' office. In addition, each patient is allowed access to specific calendar entries associated with that patient, e.g., office visits scheduled. The calendar may also include entries associated with requiring certain types of tests and shots for that patient. The calendar administrator can decide on a case-by-case basis, or for certain types of calendar events, whether such calendar entries should be shared with all patients, with a particular sub-group of patients, or only with an individual patient.

Notifications Associated with Calendar Entries

When a change is made to a calendar entry in the current system, a user may desire to receive a notification of such change, even if that user made the change. For a group calendar, all users within that particular group or a subset of group users may receive a change notification. The content of the notification may vary depending on the particular change.

For example, if a team practice has been added for a sports team, all team coaches and team players may receive notification that an event (i.e., practice) has been added for a certain time, date, and location. If a team game is added, then every user type (e.g., coach, player, parent, fan) may receive a notice that an event (i.e., game) has been added for a certain time, date, and location.

The medium used for such notification may be selectable and may vary depending on the particular notification. Options that could be selected include, for example, a phone call with a recorded voice message, a text, an e-mail, and a Facebook notification. Features integrated into a mobile device, such as the “notification” feature available on the iPhone, can be utilized for communicating any such changes. Any one, combination, or all possible mediums can be utilized for such notification.

Calendar Interoperability

Known calendaring systems such as Google Calendar, Yahoo Calendar, and the Microsoft Outlook Calendar include capabilities such as scheduling recurring events, and inviting other attendees to an event. In addition, such calendars typically can be e-mailed or otherwise shared with others (e.g., published online), and permission can be granted to allow others access to specific calendars or aspects of such calendars. While such calendars are known and commercially available, to facilitate robust use of all such calendars for individual users, groups, and organizations, such calendars can be integrated into a single calendar or a select number of calendars. Such integration can be achieved in numerous ways, including through use of well-known integration tools and platforms.

In addition to interoperability across multiple calendar platforms, interoperability can also be provided across multiple communications modalities, such as e-mail, text message, Facebook, Twitter, and other communication mediums. Systems for providing such interoperability are well known in the art. In addition, multiple communications modalities can be used for a single message or other communication (i.e., integrated use of e-mail, facebook and text message for a single message or other communication). Such integrated use of multiple modalities is well known in the art. The present methods and systems are not limited to use with any one particular calendar, nor any one particular communication modality.

### Example

### Academic Calendar

High school and college students often are enrolled in multiple classes, and separate calendars are maintained by the teacher/professor for each class. For example, in such an academic environment, each professor may make homework assignments available on-line although each student has to navigate to the web-site designated by each professor to access the assignments and other materials such as the course syllabus, and determine when the assignments are due. For example, one student enrolled in math, physics, and chemistry would navigate to three different web sites to review the course calendars for each subject. When a professor adds review sessions, quizzes, and tests to the calendar, the professor typically still announce those additions and/or changes in class and at least some students often will independently visit that particular web site to confirm the dates and times.

### Example

### Sport Calendar

Sports coaches at all levels schedule team meetings, practices, games, and other team events. Some coaches and organizations maintain a master calendar at a designated website and by navigating to that website and selecting a particular team, you can view the calendar for that selected team. When new events (e.g., an extra practice or game) are added to the calendar or changes are made to the calendar, the team participants and/or team parents can visit the designated website and view additions/changes. Such calendars, or portions of such calendars, may be subscriber based.

In addition, access to such calendars may be password protected, and permissions utilized to allow certain users access to specified calendars. For examples, coaches may have access to a calendar having entries related to games, practices, parent/player meetings, and coaches meetings. Parents may only have access, however, to a calendar having entries for games and parent/player meetings. Fans of the team may only have access to a calendar having entries for games. Access control to specific calendar entries can vary widely depending on the particular circumstance and calendar users.

### Example

### Calendar Integration in an Automobile

Many automobiles now have electronic calendars available to users. For example, mobile devices can now operate in a synchronized manner with numerous functions within an automobile including for music, contacts lists for phone calls, e-mail, and calendars. The calendar system as described herein can be utilized in combination with such calendars and accessible to a user via a user interface in an automobile.

### Example

### Social Network

Many social network applications and tools are well known. Many of such networks enable a user to post information regarding upcoming events, experiences, photographs, and other items selected by the user. While the user generally grants approval to particular other users for access to posted information (e.g., a follow request on Twitter, a friend request on Facebook), once another user has been granted access, that user has access to everything posted.

The current calendaring system and methods, the user can select which information on the calendar each other users may access. For example, the user may desire that a select group of subscribers have access to a certain social event or events on the calendar, although may desire that a totally different or overlapping group of subscribers have access to certain academic events on the calendar. In addition, the user may make certain events on the calendar “public” and any user of the calendaring system can view such an event. Rather than allowing all subscribers access to all information on the calendar, with the current systems and methods the user can be more granular with respect to which events certain subscribers can view.

The term “user”, as used herein, includes a human operator, as well as systems and applications. Therefore, the term user is not limited to being a human, and in many instances references a system or application that includes software operating on a processor.

Also, as used herein, the term “processor” refers to a digital processor, an analog processor, as well as any analog and digital circuit as well as software, including combinations thereof, capable of performing the described functions. For example, the processor could be a microprocessor, a computer, an analog circuit, a combination analog and digital circuit, a server (e.g., an e-mail server, a general purpose server), an integrated circuit, software, and any combination of the foregoing. Also, the described processing need not be performed by a single processor, but could be performed across more than processor.

While the invention has been described in terms of various specific embodiments, those skilled in the art will recognize that the invention can be practiced with modification within the spirit and scope of the claims.

What is claimed is:

1. A method for managing calendar entries, said method comprising:
receiving at a computing device, via a user interface, data related to an event, the data including at least one of an event date, an event time, an event location, and an event type,
storing the event data in a memory of the computing device,
transmitting the event data, via a communication interface of the computing device, to at least one user device,
receiving, via the computing device communication interface, event confirmation data from the user device, the confirmation data indicating receipt of the event data.

2. A method in accordance with claim 1 wherein the event data is accessible by a plurality of users, and wherein each user can elect to have the event data transmitted to at least one select user device.

3. A method in accordance with claim 2 wherein if a change is made to the event data, then a change notification is transmitted via the computing device communication interface to each select user device.

4. A method in accordance with claim 3 wherein the change notification comprises at least one of a voice message, a text message, and an e-mail.

5. A method in accordance with claim 3 wherein the event data change is transmitted via the computing device communication interface to each select user device.

6. A method in accordance with claim 1 wherein prior to receiving event data, each user subscribes to receive event data and each user designates a password used by the user to access the event data.

7. A system for managing calendar entries, said system comprising a computing device, said computing device comprising a processor, a user interface and a memory, said processor coupled to said interface and to said memory, said system configured to receive, via said user interface, data related to an event, the data including at least one of an event date, an event time, an event location, and an event type, said system further configured to store event data in said memory, to transmit the event data, via said communication interface, to at least one user device, and to receive, via said communication interface, event confirmation data from the user device, the confirmation data indicating receipt of the event data.

8. A system in accordance with claim 7 wherein the event data is accessible by a plurality of users, and wherein each user can elect to have the event data transmitted to at least one select user device.

9. A system in accordance with claim 8 wherein if a change is made to the event data, then a change notification is transmitted via said computing device communication interface to each select user device.

10. A system in accordance with claim 9 wherein the change notification comprises at least one of a voice message, a text message, and an e-mail.

11. A system in accordance with claim 9 wherein the event data change is transmitted via said computing device communication interface to each select user device.

12. A system in accordance with claim 7 wherein prior to receiving event data, each user subscribes to receive event data and each user designates a password used by the user to access the event data.

13. Computer-readable storage media having computer-executable instructions thereon, wherein when executed by at least one processor associated with a computer device and a memory device, the computer-executable instructions cause the at least one processor to:
receive data related to an event, the data including at least one of an event date, an event time, an event location, and an event type,
store the event data in a memory of the computing device,
transmit the event data, via a communication interface, to at least one user device,
receive, via the communication interface, event confirmation data from the user device, the confirmation data indicating receipt of the event data.

14. The computer-readable storage media in accordance with claim 13 wherein the event data is accessible by a plurality of users, and wherein each user can elect to have the event data transmitted to at least one select user device.

15. The computer-readable storage media in accordance with claim 14 wherein if a change is made to the event data, then the computer-executable instructions cause the at least one processor to transmit a change notification via the computing device communication interface to each select user device.

16. The computer-readable storage media in accordance with claim 15 wherein the change notification comprises at least one of a voice message, a text message, and an e-mail.

17. The computer-readable storage media in accordance with claim 16 wherein the event data change is transmitted via the computing device communication interface to each select user device.
